(19) United States
(12) Patent Application Publication
(10) Pub. No.: US 2022/0348777 A1
(43) Pub. Date: Nov. 3, 2022

(54) INKS INCLUDING RESIN ENCAPSULATED PIGMENT PARTICLES

(71) Applicant: Hewlett-Packard Development Company, L.P., Spring, TX (US)

(72) Inventor: Rajesh Kelekar, Palo Alto, CA (US)

(73) Assignee: Hewlett-Packard Development Company, L.P., Spring, TX (US)

(21) Appl. No.: 17/414,661

(22) PCT Filed: Jul. 2, 2019
(86) PCT No.: PCT/US2019/040330

§ 371 Date: Jun. 16, 2021

(51) Int. Cl. C09D 11/322; C09D 11/36; C09D 133/08; C09D 133/10; C08K 9/10

(52) U.S. Cl. CPC C09D 11/322; C09D 11/36; C09D 133/08; C09D 133/10; C08K 9/10

(57) ABSTRACT

An ink includes a dielectric, non-aqueous carrier fluid. The ink also includes pigment particles within the carrier fluid and liquid resin in a dispersed phase encapsulating each of the pigment particles within the carrier fluid. The liquid resin is to be polymerized after the ink is applied to a substrate.

### BACKGROUND

Modern printing techniques involve a wide variety of media, whether rigid or flexible, and for a wide range of purposes. In some instances, the media may be combined with additional materials and/or layers to form an assembly.

### BRIEF DESCRIPTION OF THE DRAWINGS

FIG. 1 illustrates one example of an ink.

FIG. 2 is a diagram including a side view schematically representing an example image formation medium assembly.

FIG. 3 is a diagram including a side view schematically representing an example image formation device and/or method of image formation.

FIG. 4 is a diagram including a side view schematically representing an example image formation device and/or example image formation method.

FIG. 5 is a diagram including a side view schematically representing an example image formation device and/or method of image formation.

FIG. 6A is a diagram including a side view schematically representing an example receiving structure for a fluid ejection device.

FIG. 6B is a diagram including a side view schematically representing an example fluid ejection device removably inserted relative to an example receiving structure for a fluid ejection device.

FIG. 7A is a block diagram schematically representing an example first liquid removal portion.

FIG. 7B is a block diagram schematically representing an example second liquid removal portion.

FIGS. 8A and 8B are each a diagram including a side view schematically representing an example image formation medium and an example developer unit of an example image formation device and/or example method of image formation.

FIG. 8C is a diagram including a side view schematically representing an example developer unit removably inserted into an example receiving structure and/or at least some aspects of an example method of image formation.

FIG. 9A is a diagram including a side view schematically representing an example image formation device and/or method of image formation.

FIG. 9B is a diagram including a side view schematically representing an example image formation medium assembly.

FIGS. 10 and 11 each include a diagram including a side view schematically representing an example image formation device and/or method.

FIGS. 12A and 12B are block diagrams schematically representing an example control portion and an example user interface, respectively.

FIGS. 13A and 13B are flow diagrams schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

At least some examples of the present disclosure are directed to inks and devices and/or methods to enhance a robustness of an image formation medium assembly, including but not limited to, binding pigment particles to various layers or structures of the image formation medium assembly.

In some examples, an ink includes a dielectric, non-aqueous carrier fluid, pigment particles within the carrier fluid, and liquid resin in a dispersed phase encapsulating each of the pigment particles within the carrier fluid. The liquid resin is to be polymerized after the ink is applied to a substrate to bind the pigment particles to the substrate.

The inks disclosed herein including a resin in the dispersed phase provide several advantages compared to inks without a resin. For example, ink including the resin in the dispersed phase provides better adhesion to many substrates, such as textiles. The resin in the dispersed phase also increases the viscosity of the ink for improved jettability. High viscosity or long chain polymer resins may be used without increasing the viscosity of the ink too much for jettability. Incorporating the resin as an emulsion preserves an additional advantage of making evaporation less energy intensive. The resin in the dispersed phase may be electrostatically pinned. The resin also increases the solvent resistance of dried ink layers. In addition, for liquid resins, a film is easily created such that the extra energy required to turn solid particles into a film is not needed (i.e. the film-forming temperature need not be exceeded).

In some examples, an image formation device includes a supply, a first portion, and a second portion. The supply is to supply a non-transfer media along a travel path and to which a ground element is to be electrically connected. The first portion is along the travel path to apply droplets resin encapsulated pigment particles within a dielectric, non-aqueous carrier fluid onto the non-transfer media to form at least a portion of an image on the media. The second portion is downstream from the first portion and includes a charge generation portion to emit airborne charges to charge the resin encapsulated pigment particles to move, via attraction relative to the grounded media, through the carrier fluid toward the media to become electrostatically fixed relative to the media.

In some examples, the resin in the dispersed phase includes a solid resin (e.g. a thermoplastic polymer) encapsulating the pigment particles. In other examples, the resin in the dispersed phase includes a liquid resin (e.g. a thermoplastic polymer dissolved in a solvent or a thermosetting polymer) encapsulating the pigment particles. In some examples, the image formation device also includes a third portion downstream from the second portion to polymerize the resin (e.g. for thermosetting polymers) via UV radiation or heat.

In some examples, the image formation device may sometimes be referred to as a printer or printing device. In some examples in which a media is supplied in a roll-to-roll arrangement or similar arrangements, the image formation device may sometimes be referred to as a web press and/or the media can be referred to as a media web.

At least some examples of the present disclosure are directed to forming an image directly on an image formation medium, such as without an intermediate transfer member. Accordingly, in some instances, the image formation may sometimes be referred to as occurring directly on the image formation medium. However, this does not necessarily exclude some examples in which an additive layer (e.g. a first polymer structure) may be placed on the image formation medium prior to receiving ink particles (within a carrier fluid) onto the media. In some instances, the image formation medium also may sometimes be referred to as a non-transfer media to indicate that the image formation medium itself does not include a transfer member (e.g. transfer blanket, transfer drum) by which an ink image is to be later transferred to another media (e.g. paper or other material). In this regard, the image formation medium may sometimes also be referred to as a final image formation medium or a media product. In some such instances, the image formation medium may sometimes be referred to as product packaging media or product packaging image formation medium. Similarly, after application of a second polymer structure, via heat and pressure, a completed image formation medium assembly may sometimes be referred to as a product packaging, image formation medium assembly or a product packaging media assembly.

In some examples, the image formation medium comprises a non-absorbing image formation medium. Stated differently, in some examples the image formation medium is made of a material which does not absorb liquids, such as a carrier fluid and/or other liquids in the droplets received on the image formation medium. In one aspect, in some such examples the non-absorbing image formation medium does not permit the liquids to penetrate, or does not permit significant penetration of the liquids, into the surface of the non-absorbing image formation medium.

Via the example arrangements, the example device and/or associated methods can print images on a non-absorbing image formation medium (or some other media) with minimal bleeding, dot smearing, etc. while permitting high quality color on color printing. Moreover, via these examples, image formation on a non-absorbing image formation medium (or some other media) can be performed with less time, less space, and less energy at least due to a significant reduction in drying time and capacity. These example arrangements stand in sharp contrast to other printing techniques, such as high coverage, aqueous-based step inkjet printing onto non-absorbing media for which bleeding, dot smearing, cockling, etc. may yield relatively lower quality results, as well as unacceptably high cost, longer times, etc. associated with drying.

In some examples, the first portion of the image formation device includes a receiving structure to receive a fluid ejection device with the fluid ejection device to deliver the droplets of resin encapsulated pigment particles within the dielectric carrier fluid on the non-transfer media to form at least a portion of an image on the media. In some examples, the droplets may sometimes be referred to as being jetted onto the media. With this in mind, example image formation according to at least some examples of the present disclosure may sometimes be referred to as “jet-on-media” or “jet-on-substrate.” In some examples, the fluid ejection device is to eject/deposit the dielectric carrier fluid on the media as a non-aqueous fluid. In some examples, the non-aqueous fluid comprises an isoparrafinic fluid or other oil-based liquid suitable for use as a dielectric carrier fluid.

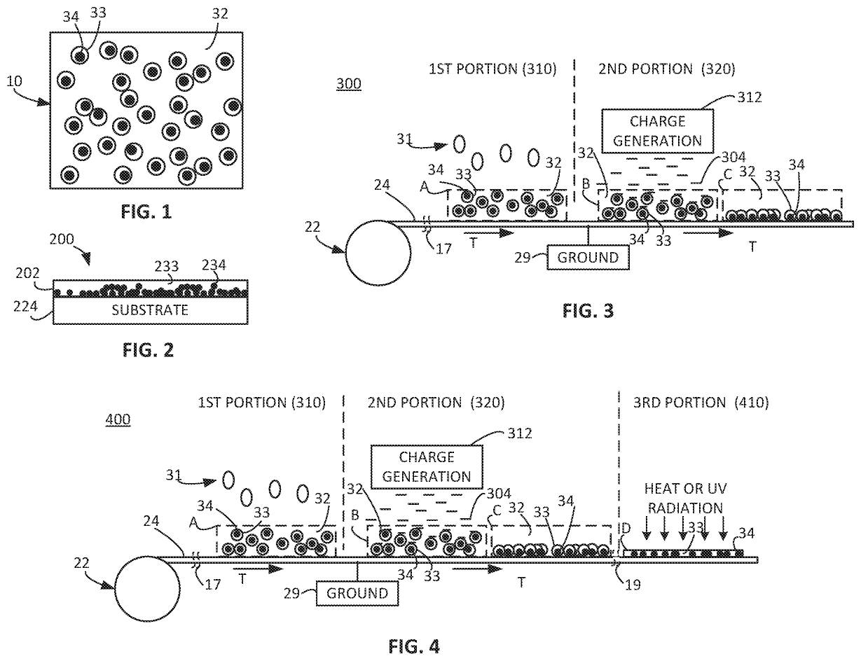

These examples, and additional examples, will be further described below in association with at least FIGS. 1-13B.

FIG. 1 illustrates one example of an ink 10. Ink 10 includes a dielectric, non-aqueous carrier fluid 32, pigment particles (e.g. ink particles) 34 within the carrier fluid 32, and resin 33 in a dispersed phase encapsulating each of the pigment particles 34 within the carrier fluid 32. The resin 33 is insoluble or has a very small solubility in the carrier fluid 32. That is, the solubility of resin 33 in the carrier fluid is small enough such that the resin 33 can encapsulate the pigment particles 34. Resin 33 may consist primarily of organic components that can be cured and/or polymerized to a solid by some means, such as by evaporation, ultraviolet (UV) polymerization, and/or by thermal polymerization.

In one example, the resin 33 is a liquid resin in a dispersed phase encapsulating each pigment particle 34. In this case, the resin 33 may be a thermoplastic polymer dissolved in a solvent, or a thermosetting polymer (with or without a solvent). The thermoplastic polymer may include, for example, polyvinylpyrrolidone, polyacrylamide, polyvinylalcohol, carboxymethyl cellulose, polyanionic cellulose, hydroxypropyl methylcellulose, polyethylene glycol, polyacrylic acid, N-(2-hydroxypropyl) methacrylamide, Divinyl Ether-Maleic Anhydride, Polyoxazoline, Xanthan gum, and Chitosan. The polar solvents that may be used include, for example, water, ethanol, methanol, isopropanol, acetone, acetonitrile, methyl ethyl ketone, n-butanol, dimethylformamide, N-Methyl-2-pyrrolidone, formic acid, glycerin, and/or dimethylacetamide. The thermosetting pre-polymers may include, in general prepolymers with acrylates/methacrylate functionalities, a combination of pre-polymers with polyester functionalities and with styrene functionalities, a combination of pre-polymers with thiol and alkene functionalities, a combination of pre-polymers with isocyanate functionalities and with hydroxyl functionalities, and/or pre-polymers with epoxide, vinyl ether, and oxetane functionalities. The thermosetting polymer with (meth)acrylate functionality may include, for example, at least one of polyethylene glycol diacrylate, hydroxyethyl methacrylate, propxylated glcyercol triacrylate, ethoxylated tri methylolpropane triacrylate, CN2262/CN2271E/CN2302/CN2303 from Sartomer, and BDT-1006/BDT-4330/BR-371S/BR-990/BR-3641AJ/BR-3741AJ from Dymax. The thermosetting polymer with epoxide, vinyl ether, and oxetane functionalities may include, for example, ethylene glycol diglycidyl ether, polyethylene glycol diglycidyl ether, dioxetanyl ether, 2-ethyl hexyl oxetane, oxetane biphenyl, 3,4-epoxycyclohexylmethyl-3′,4′-epoxycyclohexane carboxylate, ϵ-Caprolactone, 2-oxepanone, and/or polymer with 1,4-cyclohexanedimethanol. The liquid resin may also include dissolved additives, including, but not limited to photo-initiators, salts, catalysts, etc. In another example, the resin 33 may be a solid resin encapsulating each pigment particle 34, such as a thermoplastic polymer (e.g., polyvinylpyrrolidone).

In some examples, the ink 10 may be produced by mixing the carrier fluid 32, the pigment particles 34, and a dispersant (e.g. Solsperse J561 or J910 from Lubrizol) and wet grinding the mixture to disperse the pigment particles. Next, a resin 33 that has an affinity for the pigment particles 34 and optionally an additional dispersant may be added and ultrasonication may be used to incorporate the resin to provide the resin encapsulated pigment particles. In some examples, the ink 10 may be produced by making the pigment dispersion (pigment dispersed in dielectric liquid, consisting of pigment, dispersant, and liquid) separately by wet grinding, ultrasonication, microfluidization, etc. Next, the resin emulsion (resin emulsified in dielectric liquid, consisting of resin, emulsifier, and liquid) is made by ultrasonication or microfluidization. Finally, the pigment dispersion and the resin emulsion are combined in the desired proportions, and ultrasonication or microfluidization is used to achieve encapsulation. In other examples, the ink 10 may be produced by making the pigment dispersion (pigment dispersed in dielectric liquid, consisting of pigment, dispersant, and liquid) separately by wet grinding, ultrasonication, microfluidization, etc. Next, the resin and emulsifier are added in the desired proportions, and ultrasonication or microfluidization is used to achieve encapsulation. In yet other examples, the whole ink 10 may be produced at once by mixing pigment, dispersant, resin, emulsifier, and liquid and then processing with ultrasonication or microfluidization. The emulsifier may include, for example, Solsperse J561/J910/J981/13940/67000 from Lubrizol, Hypermer B210/B246/A70 from Croda, Silcare SEA from Clariant, Decaglycerol monooleate, Lutensol TDA3 from BASF, WE09/EM90/EM180 from Evonik, sodium docusate (AOT), polyglycerol-10 monooleate, Span 80, and/or Span 85.

FIG. 2 is a diagram illustrating a side view schematically representing an example image formation medium assembly 200. Image formation medium assembly 200 includes a substrate 224 and a first polymer structure 202. First polymer structure 202 is formed by curing an ink 10 that has been deposited onto the substrate 224 to provide polymerized resin 233 and ink solids 234. For a resin 33 including either a thermoplastic polymer or a thermosetting polymer, a first heating process may be used to evaporate the carrier fluid 32 after the ink 10 has been deposited onto the substrate 224. For a resin 33 including a thermoplastic polymer, the first heating may also evaporate a solvent in which the thermoplastic polymer is dissolved. For a resin 33 including a thermosetting polymer, a second heating process or ultraviolet (UV) radiation may be used to polymerize the resin. For a resin 33 including a solid resin, a second heating process may be used to melt and coalesce the resin. In any case, after curing and/or polymerization of the resin 33, the resin is coalesced as indicated by 233 and binds the ink solids 234 to the substrate 224.

In some examples, the completed image formation medium assembly 200 of FIG. 2 may be used in the flexible packaging market. In some examples, such flexible packaging may include food packaging. In some such examples of food packaging, the substrate 224 (i.e. image formation medium) of completed assembly 200 may face or enclose the food contained with the package formed from completed assembly 200. Meanwhile, the first polymer structure 202 may face or be exposed to the consumer, user, etc.

FIG. 3 is a diagram including a side view schematically representing an example image formation device 300 and/or method of image formation. As shown in FIG. 3, in some examples an image formation device 300 includes an image formation medium supply 22, a first portion 310, and a second portion 320. The image formation medium supply 22 is to supply image formation medium 24 along a travel path T and to which a ground element 29 is electrically connectable. In some examples, image formation medium supply 22 may comprise a roll of image formation medium which is fed and moved along travel path T via support from an array of rollers to maintain tension and provide direction to the image formation medium along travel path T. In some instances, the image formation medium may be referred to as a media and the image formation medium supply 22 may sometimes be referred to as a media supply.

In some examples, image formation medium 24 includes an electrically conductive (e.g. e-conductive) material, such as but not limited to a metallized material, layer, or foil to which a ground element 29 is electrically connected. In some instances, the image formation medium 24 may be referred to as a metallic media or metalized media. In some examples, an electrically conductive element separate from the e-conductive image formation medium 24 is provided to contact the image formation medium 24 to implement grounding of the image formation medium 24. In some examples, the electrically conductive element may include a roller or plate in rolling or slidable contact, respectively, with a portion of the image formation medium. In some examples, the ground element 29 is in contact with an edge or end of the image formation medium. In some examples, the electrically conductive element may take other forms, such as a brush or other structures. Accordingly, it will be understood that the ground element 29 is not limited to the particular location shown in FIGS. 3-5 and 9A-11.

In some such examples, the non-absorptive image formation medium 24 may include other attributes, such as acting as a protective layer for items packaged within the image formation medium. Such items may comprise food or other sensitive items for which protection from moisture, light, air, etc. may be desired.

With this in mind, in some examples the image formation medium 24 may include a plastic media. In some examples, the image formation medium 24 may include polyethylene terephthalate (PET) material, which may include a thickness on the order of about 10 microns. In some examples, the image formation medium 24 may include a biaxially oriented polypropylene (BOPP) material. In some examples, the image formation medium 24 may include a biaxially oriented polyethylene terephthalate (BOPET) polyester film, which may be sold under trade name Mylar in some instances. In some such examples of using PET or BOPP or BOPET or similar materials, the image formation medium 24 also may include a metal backing layer to provide electrical conductivity.

With this in mind, in some examples, the image formation medium 24 may include additional types or other types of materials which provide at least some of the features and attributes as described throughout the examples of the present disclosure. For example, the image formation medium 24 or portions of image formation medium 24 may include a metallic component, such as a metallized foil, metal layer, etc. among other types of materials. The metal component may act as a moisture and oxygen barrier to protect the safety and freshness of the food or to protect other attributes of sensitive non-food contents. In some examples, the metallic component of the image formation medium 24 and/or other components of the image formation medium 24 may be present as part of the image formation medium supply 22, while in some examples, such components may be added after or as the image formation medium 24 is released from the supply 22.

As shown in FIG. 3, in some examples the first portion 310 of image formation device 300 is located along and/or forms a portion of the travel path T, and is to apply droplets 31 of resin encapsulated pigment particles within a dielectric carrier fluid 32 onto the image formation medium 24. The depiction within the dashed lines A in FIG. 3 represents ink particles 34, resin 33 in a dispersed phase encapsulating each of the pigment particles 34, and carrier fluid 32 after being received on image formation medium 24 to form at least a portion of an image on the image formation medium 24. In some examples, the droplets 31 from which resin encapsulated ink particles 34 are formed may include pigments, resin 33 in the dispersed phase, dispersants, and the carrier fluid 32.

Among other attributes, the resin 33 may act to bind the ink particles 34 to the image formation medium 24 of a completed image formation medium assembly, as described with reference to FIG. 2.

As further shown by the curved break lines 17 along travel path T, in some examples the image formation device (and/or method) may include portions or action preceding the first portion 310.

As shown in FIG. 3, the second portion 320 is located downstream along the travel path T from the first portion 310. The second portion 320 includes a charge generation portion 312 to emit airborne charges 304 to charge the resin encapsulated ink particles, as represented via the depiction in dashed lines B in FIG. 3. Once charged, resin encapsulated ink particles move, via attraction relative to the grounded image formation medium 24, through the carrier fluid 32 toward the image formation medium 24 to become electrostatically fixed (i.e. pinned) on the image formation medium 24, as represented via the depiction in dashed lines C in FIG. 3. Via such pinning and the later described removal of excess liquid (e.g. carrier fluid 32), the pinned resin encapsulated ink particles 34 (e.g. pigments) form a layer of ink solids and resin in a pattern corresponding to an image to be formed on the image formation medium. As further shown within dashed lines C, the carrier fluid 32 becomes supernatant with respect to the layer of ink solids and resin electrostatically pinned relative to image formation medium 24.

With further reference to FIG. 3, in some examples the charge generation device 312 in the second portion 320 may include a corona, plasma element, or other charge generating element to generate a flow of charges. The generated charges may be negative or positive as desired. In some examples, the charge generation device 312 may include an ion head to produce a flow of ions as the charges. It will be understood that the term “charges” and the term “ions” may be used interchangeably to the extent that the respective “charges” or “ions” embody a negative charge or positive charge (as determined by device 312) which can become attached to the resin encapsulated ink particles to cause all of the resin encapsulated ink particles to have a particular polarity, which will be attracted to ground. In some such examples, all or substantially all of the resin encapsulated ink particles will have a negative charge or alternatively all or substantially all of the resin encapsulated ink particles will have a positive charge.

Via such example arrangements, the charged resin encapsulated ink particles become electrostatically fixed on the image formation medium 24 in a location on the image formation medium 24 generally corresponding to the location (in an x-y orientation) at which they were initially applied onto the image formation medium 24 in the first portion 310 of the image formation device 300. Via such electrostatic fixation, the resin encapsulated ink particles will retain their position on image formation medium 24 even when other ink particles (e.g. different colors) are added later, excess liquid is physically removed, etc. It will be understood that while the ink particles may retain their position on image formation medium 24, some amount of expansion of a dot (formed of ink particles) may occur after the ink particles 34 (within carrier fluid 32) are jetted onto image formation medium 24 and before they are electrostatically pinned. In some examples, the charge generation device 312 is spaced apart by a predetermined distance (e.g. downstream) from the location at which the droplets are received (or ejected) to delay the electrostatic fixation (per operation of charge generation device 312), which can increase a dot size on image formation medium 24, which in turn may lower ink consumption.

FIG. 4 is a diagram including a side view schematically representing an example image formation device 400 and/or example image formation method. Image formation device 400 includes a third portion 410 downstream from the second portion 320 and in which heat or UV radiation may be used to polymerize the resin 33.

As further shown by the curved break lines 17 along travel path T, in some examples the image formation device (and/or method) may include portions or action preceding the first portion 310. Similarly, as further shown by the curved break lines 19 along travel path T, in some examples the image formation device (and/or method) may include portions or action following the second portion 320 and preceding the third portion 410.

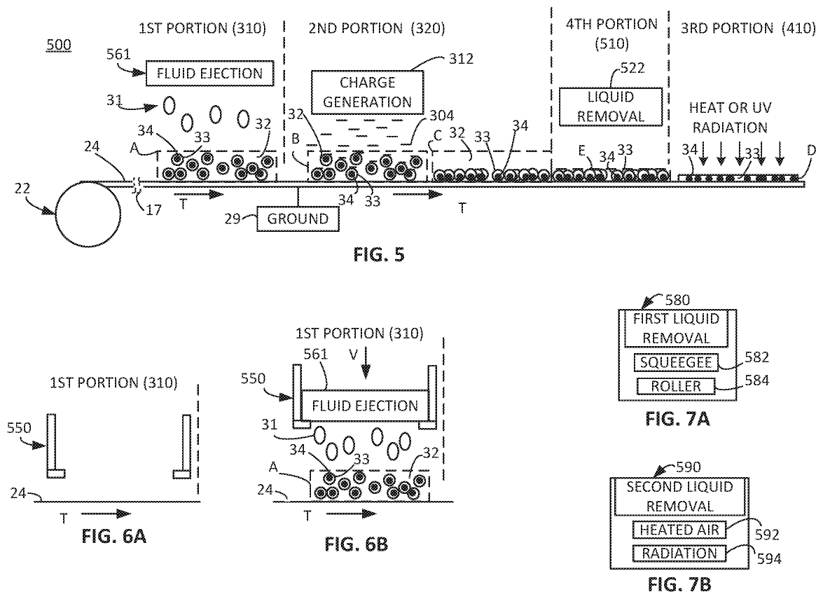

It will be understood that in some examples, prior to the polymerization of the resin 33 in third portion 410, the image formation device 400 may include a liquid removal portion to remove excess liquid (e.g. primarily carrier fluid) and dry the ink particles on the image formation media. At least some such example implementations are described later in association with at least FIGS. 5, 7A-7B, 9A, and 10-11.

With further reference to FIGS. 1-4, in some examples the resin 33 may include about 10 percent (e.g. 9.8, 9.9, 10, 10.1, 10.2) to about 25 percent (24.8, 24.9, 25, 25.1, 25.2) volume of the total volume of fluid ejected as droplets 31, with it being understood that the droplets 31 include ink particles 34 (e.g. pigment), the dielectric carrier fluid 32, dispersant, and the resin 33 encapsulating each ink particle 34. In other examples, the resin 33 may include about 12 percent (e.g. 11.8, 11.9, 12, 12.1, 12.2) to about 20 percent (e.g. 19.8, 19.9, 20, 20.1, 20.2) volume of the total volume of fluid ejected as droplets 31. In other examples, the resin 33 may include about 15 percent (e.g. 14.8, 14.9, 15, 15.1, 15.2) to about 40 percent (e.g. 39.8, 39.9, 40, 40.1, 40.2) by volume of the total volume of fluid ejected as droplets 31. In general, the resin 33 may include about 5 percent to about 50 percent of the total volume of fluid ejected as droplets 31 and the emulsifier may include about 1 percent to about 50 percent of the weight of the resin.

In some examples, the resin 33 may include a molecular weight of less than about 50,000 atomic mass units. In some such examples, the resin 33 may include an atomic weight less than about 60,000, less than about 55,000, or less than 45,000 atomic mass units.

Via such example arrangements involving these relatively short molecular lengths, the resin 33 increases the binding of the ink particles to the image formation medium assembly after coalescing the resin without the resin 33 otherwise interfering with the jettability of the droplets 31 (such as from a fluid ejection device) and/or without the resin 33 interfering with the dispersability of the pigments within the carrier fluid 32.

In some examples, the above-described resin 33 may exhibit sufficient jettability, such as the droplets 31 (formed by a fluid ejection device) including single droplets formed at least about 1 millimeter away from the nozzle through which the droplet 31 is ejected. In some examples, the resin 33 does not interfere with a stability of the ink at least with agglomeration. In other words, addition of the resin does not interfere with desired agglomeration of ink particles 34. In some examples, the addition of the resin 33 to the other components of the droplets 31 (e.g. carrier fluid 32, dispersant, and ink particles 34) does not modify the optical properties (e.g. opacity, density, etc.) of the droplets 31 by more than about 5 percent.

In some examples, such as when the resin 33 includes a thermosetting polymer, the droplets 31 may include a pigment content of about 6 percent (e.g. 5.8, 5.9, 6, 6.1, 6.2) to about 9 percent (e.g. 8.8, 8.9, 9, 9.1, 9.2) by volume of the fluid forming droplets 31. In some such examples, the dielectric carrier fluid 32 may include about 65 percent (e.g. 64.8, 64.9, 65, 65.1, 65.2) volume to about 80 percent (e.g. 79.8, 79.9, 80, 80.1, 80.2) volume of the fluid forming droplets 31. In some examples, the dielectric carrier fluid 32 may include about 68 percent (e.g. 67.8, 67.9, 68, 68.1, 68.2) volume to about 75 percent (e.g. 74.8, 74.9, 75, 75.1, 75.2) volume of the fluid forming droplets 31. In some examples, the dielectric carrier fluid 32 may include about 70 percent (e.g. 69.8, 69.9, 70, 70.1, 70.2) by volume of the fluid forming droplets 31.

In some examples, the fluid forming droplets 31 may include about 69 percent (e.g. 68.8, 68.9, 69, 69.1, 69.2) by volume of carrier fluid 32, 7 percent (e.g. 6.8, 6.9, 7, 7.1, 7.2) by volume of pigment (e.g. 34), about 6 percent (e.g. 5.8, 5.9, 6, 6.1, 6.2) by volume of dispersant, and 18 percent (e.g. 17.8, 17.9, 18, 18.1, 18.2) by volume of resin 33.

It will be understood that in some examples of resins 33 including other specific thermosetting polymers or thermoplastic polymers, the particular percentage by volume of the components of carrier fluid 32, ink particles 34, dispersant, and resin 33 may be similar to the numerical percentages and/or ranges noted above or they may vary.

FIG. 5 is a diagram including a side view schematically representing an example image formation device 500 and/or aspects of an example image formation method. In some examples, device 500 includes at least some of substantially the same features and attributes as devices 300 and 400 previously described in association with FIGS. 3-4.

As shown in FIG. 5, the image formation device 500 includes an image formation medium supply 22, first portion 310, second portion 320, and third portion 410 having substantially the same features and attributes as in device 400 of FIG. 4.

With further reference to FIG. 5, in some examples, the first portion 310 of image formation device 500 includes a fluid ejection device 561 to eject the droplets 31 of resin encapsulated ink particles (within the carrier fluid 32). The fluid ejection device 561 is positionable at a location spaced apart and above the image formation medium 24. In some examples, the fluid ejection device 561 includes a drop-on-demand fluid ejection device. In some examples, the drop-on-demand fluid ejection device includes an inkjet printhead. In some examples, the inkjet printhead includes a piezoelectric inkjet printhead. In some examples, the fluid ejection device 561 may include other types of inkjet printheads, such as but not limited to thermal ink jet printheads.

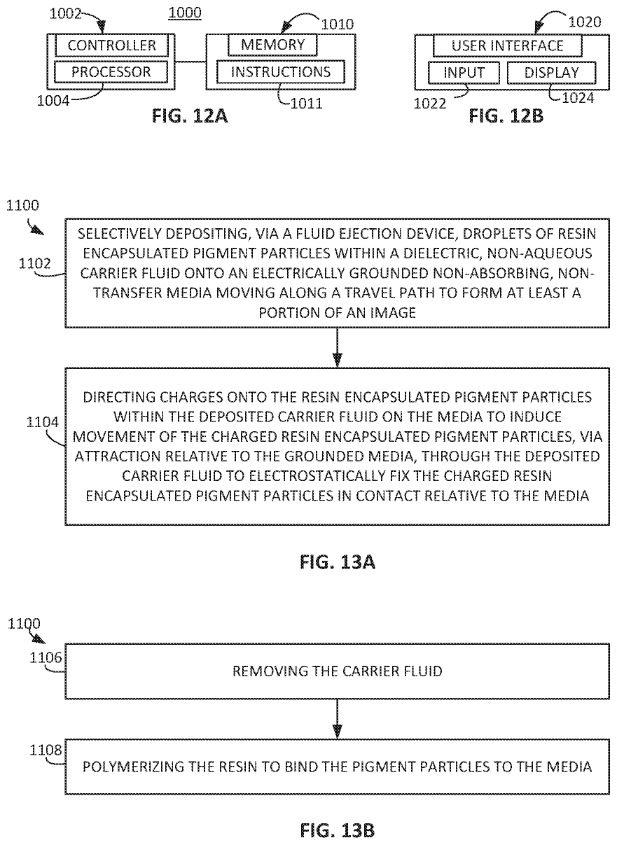

In some examples, as further described later in association with at least FIG. 12A, among directing other and/or additional operations, a control portion 1000 is to instruct or to cause the fluid ejection device 561 (FIG. 5) to deliver the droplets of resin encapsulated ink particles (and dispersants) within the dielectric carrier fluid 32 onto the image formation medium 24, such as within the first portion 310 along the travel path T of the image formation medium 24.

As further shown in FIG. 6A, in some examples the first portion 310 of the example image formation devices 300, 400, 500 may include a first receiving structure 550 to removably receive the fluid ejection device 561, such as in some examples in which the fluid ejection device 561 is removably insertable into the first receiving structure 550. The first receiving structure 550 is sized, shaped, and positioned relative to image formation medium 24, as well as relative to other components of an image formation device (e.g. 300, 400, 500, etc.) such that upon removable insertion relative to first receiving structure 550 (as represented by arrow V), the fluid ejection device 561 is positioned to deliver (e.g. eject) the droplets 31 of resin encapsulated ink particles (and dispersants) within dielectric carrier fluid 32 onto image formation medium 24, as shown in FIG. 6B. In some such examples, the fluid ejection device 561 may include a consumable which is periodically replaceable due to wear, exhaustion of an ink supply, etc. In some such examples, the fluid ejection device 561 may be sold, supplied, shipped, etc. separately from the rest of the image formation device and then installed into the image formation device upon preparation for use of the image formation device at a particular location. The first receiving structure 550 may sometimes be referred to as a first receptor.

With further reference to at least FIGS. 3, 6A, 6B, in some examples, as part of ejecting droplets (e.g. 31 in FIG. 5), the fluid ejection device 561 is to deposit the dielectric carrier fluid 32 on the image formation medium 24 as a non-aqueous liquid. In some examples, the non-aqueous liquid includes an isoparrafinic fluid, which may be sold under the trade name ISOPAR. In some such examples, the non-aqueous liquid may comprise other oil-based liquids suitable for use as a dielectric carrier fluid.

As further shown in FIG. 5, in some examples, the image formation device 500 also includes a fourth portion 510, including a liquid removal element 522, downstream along the travel path T from the charge generation portion 312 (in second portion 320) to remove at least a portion of the carrier fluid 32 (and any other excess liquids) from the image formation medium 24. In some examples, the liquid removal element 522 is to remove the carrier fluid 32 without heating the fluid 32 at all or without heating the carrier fluid 32 above a predetermined threshold. In some instances, such liquid removal may sometimes be referred to as cold liquid removal by which the liquid is removed at relatively cool temperatures, at least as compared to high heat drying techniques. Among other aspects, this arrangement may significantly reduce drying time, space used for drying, and/or costs associated with drying. In some such examples, a mechanical element (e.g. squeegee roller) of the liquid removal element 522 may slightly heat the carrier fluid 32 and/or other liquid without using heat as a primary mechanism to remove the carrier fluid 32 from the resin encapsulated ink particles on image formation medium 24.

As previously noted, once the resin encapsulated ink particles become pinned against substrate 24 as shown in dashed lines C in at least FIG. 5, the carrier fluid 32 exhibits supernatant-like behavior by its suspension above the layer of resin encapsulated ink particles pinned against the image formation medium 24. Accordingly, this arrangement facilitates mechanical removal of such liquid without disturbing the pinned resin encapsulated ink particles.

As further shown in FIG. 7A, liquid removal element 522 may include a first liquid removal portion 580, which includes a squeegee 582 and/or roller 584 or other mechanical structure to remove the carrier fluid 32 (and any other liquid) from the surface of image formation medium 24. In some examples, the electrostatically fixed (e.g. pinned) charged resin encapsulated ink particles remain fixed in their respective locations on image formation medium 24 during this physical removal of liquid at least because the electrostatic fixation forces are greater than the shear forces exhibited via the tool(s) used to mechanically remove the carrier fluid 32. In this fourth portion 510, in some examples, at least 80 percent of the jetted carrier fluid 32 on image formation medium 24 is removed. In some examples, at least 90 percent of the jetted carrier fluid 32 is removed. In some examples, at least 95 percent of the jetted carrier fluid 32 is removed. However, in some examples, first liquid removal portion 580 may remove at least 50 percent of total liquid, which includes the carrier fluid 32, from image formation medium 24.

In some such examples, performing such cold liquid removal may substantially decrease the amount of energy used to remove deposited liquid (e.g. from the top of image formation medium 24) as compared to using a heated air dryer primarily or solely to remove the liquid. In some examples, in this context the term “substantially decrease” may correspond to at least 10×, at least 20×, or at least 30×. In addition, using cold liquid removal via example image formation devices may significantly decrease the space or volume occupied by such an example image formation device, thereby reducing its cost and/or cost of space in which the image formation device may reside.

As further shown in FIG. 7B, in some examples the liquid removal element 522 in fourth portion 510 of image formation device 500 (FIG. 5) may include a second liquid removal portion 590 which would be located downstream from the first liquid removal portion 580 (FIG. 7A). The second liquid removal portion 590 acts to remove any liquid not removed via first liquid removal portion 580 and thereby result in dried ink particles 34 and resin 33 as a liquid (e.g. for a thermosetting polymer) or a solid (e.g. for a thermoplastic polymer) on the image formation medium 24, as represented via the depictions in dashed lines E in FIG. 5.

As further shown in FIG. 7B, in some examples the second liquid removal portion 590 may include a heated air element 592 to direct heated air onto at least the carrier fluid 32, image formation medium 24, etc. In some examples, the heated air is controlled to maintain the ink particles 34, resin 33, image formation medium 24, etc. at a temperature below 60 degrees C., which may prevent deformation of image formation medium 24 such as cockling, etc.

In some examples, the second liquid removal portion 590 may include a radiation element 594 to direct at least one of infrared (IR) radiation and ultraviolet (UV) radiation onto the carrier fluid 32 (and any other excess liquid) and image formation medium 24 to eliminate liquid remaining after operation of the first liquid removal portion 580. In some examples, the second liquid removal portion 590 may sometimes be referred to as an energy transfer mechanism or structure by which energy is transferred to the liquid 32, ink particles 34, resin 33, and image formation medium 24 in order to dry the ink particles 34, resin 33, and/or image formation medium 24.

Moreover, it will be understood that in some examples the labeling of the various portions as first, second, third, fourth portions (e.g. 310, 320, 410, 510, etc.) does not necessarily reflect an absolute ordering or position of the respective portions along the travel path T. Moreover, such labeling of different portions also does not necessarily represent the existence of structural barriers or separation elements between adjacent portions of the image formation devices 300, 400, 500, etc. Furthermore, in some examples, the components of the example image formation devices 300, 400, 500, etc. may be organized into a fewer or greater number of portions than represented in FIGS. 3-5, 8A, 9, etc.

With further reference to at least FIG. 5, in some examples media supply 22 may include a plurality of rollers to support and guide image formation medium 24 along travel path T. While not shown for illustrative simplicity, additional rollers may be present to support image formation medium 24 throughout each of the different portions of an image formation device. In some examples, these arrangements of rollers may include a roll-to-roll arrangement.

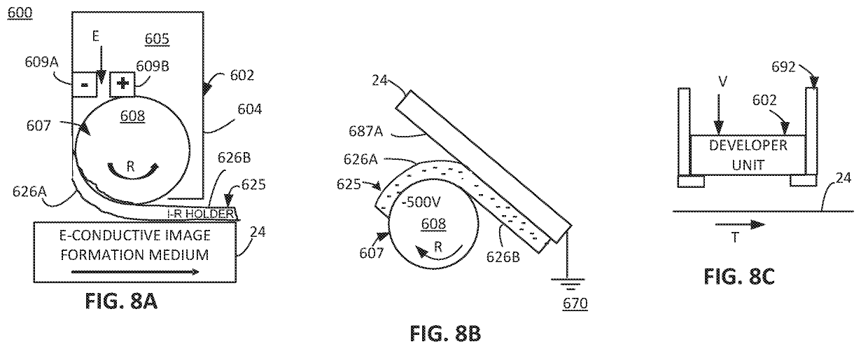

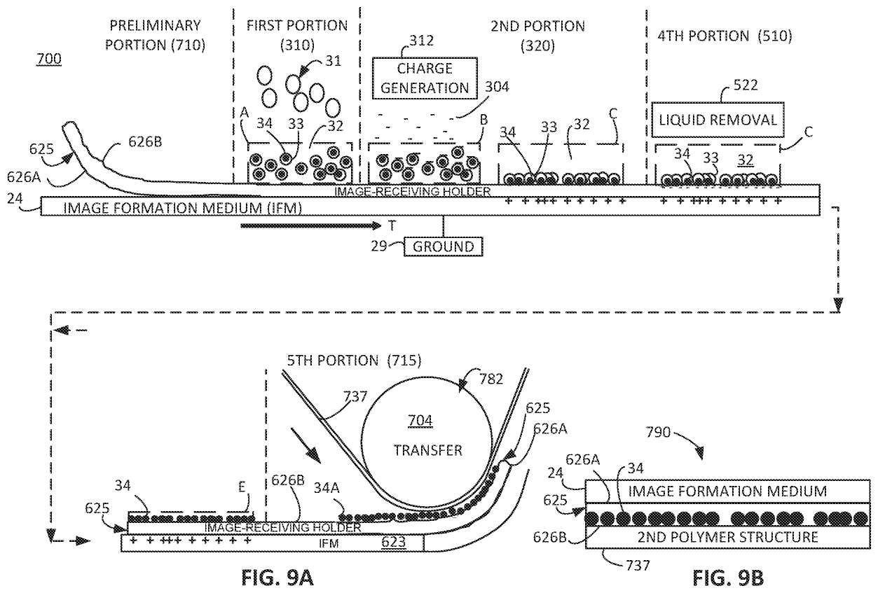

In some examples, an image formation device (e.g. 300, 400, 500, etc.) may include a preliminary portion (e.g. 710 in FIG. 9A) by which some materials or layer may be deposited onto image formation medium 24 prior to the first portion 310 in which droplets 31 of resin encapsulated ink particles within carrier fluid 32 are received onto the image formation medium 24. With this in mind, FIG. 8A provides a diagram 600 schematically representing one example developer unit 602 by which such materials or layers may be deposited onto image formation medium 24 prior to receiving droplets 31.

In some examples, the developer unit 602 may include at least some of substantially the same features and attributes as a developer unit as would be implemented in a liquid electrophotographic (LEP) printer, such as but not limited to, an Indigo brand liquid electrophotographic printer sold by HP, Inc. In some examples, the developer unit may include a binary developer (BID) unit. In some examples, the developer unit 602 may include at least some of substantially the same features and attributes of a binary developer (BID) unit as described in Nelson et al. US20180231922.

As shown in FIG. 8A, in some examples, the developer unit 602 includes a container 604 for holding various materials 605 (e.g. liquids and/or solids) from which a formulation is developed into semi-liquid, image-receiving holder layer 625. The materials 605 may include binding materials, such as resin particles, dissolved resin, binding polymers (dissolved or as resins), or adhesion promoting materials, as well as materials such as (but not limited to) dispersants, charge directors, mineral oils, foam depressing agents, UV absorbers, cross linking initiators and components, heavy oils, blanket release promoters, and/or scratch resistance additives. In one aspect, the materials 605 in any given formulation of the image-receiving holder layer 625 are combined in a manner such that materials 605 will be flowable to enable formation of the image-receiving holder as a layer 625 on image formation medium 24. In some examples, a mineral oil portion of the materials 605 may be more than 50 percent by weight of all the materials 605. In some such examples, the mineral oil portion may include an isoparrafinic fluid. In some examples, the binding materials may facilitate the electrostatic force fixation of the ink particles 34 and the resin 33 in the dispersed phase relative to the image-receiving holder layer 625, as previously described in association with at least FIG. 5.

However, it will be understood that the resins and binders associated with image-receiving holder layer 625 are not duplicative of the example resin 33 within droplets 31 by which the ink particles 34 are also bound to the image-receiving holder layer 625 of a completed image formation assembly.

In some examples, the container 604 may include individual reservoirs, valves, inlets, outlets, etc. for separately holding at least some of the materials 605 and then mixing them into a desired paste material to form an image-receiving holder as layer 625. In some examples, the developed paste may include at least about 20 percent to about 30 percent solids, which may include resin or binder components and may include at least charge director additives along with the binder materials. In some examples, the solids and charge director additives are provided within a dielectric carrier fluid, such a non-aqueous fluid, such as but not limited to the above-described isoparrafinic fluid.

As further shown in FIG. 8A, the developer unit 602 includes a roller assembly 607 disposed at least partially within container 604 and selectively exposed to the formulated paste used to form image-receiving holder layer 625. The roller assembly 607 includes a developer drum 608 (or roller), which is driven to a negative voltage (e.g. −500 V) for electrostatically charging the paste and electrostatically delivering the charged paste as image-receiving holder layer 625 on the image formation medium 24, as shown in FIGS. 8A-8B. In one such example, the paste of materials 605 is negatively charged. In some examples, the charge director additives receive and hold the negative charge in a manner to thereby negatively charge at least the binder materials within the paste of materials 605 when an electrical field is applied to the paste of materials 605, such as via the development roller 608 at −500 Volts. Via such example arrangements, the image-receiving holder layer 625 may sometimes be referred to as an electrically charged, image-receiving holder layer.

In some examples, the developer drum or roller 608 may include a conductive polymer, such as but not limited to polyurethane or may include a metal material, such as but not limited to, aluminum or stainless steel.

In some examples, the materials 605 may start out within the container 604 (among various reservoirs, supplies) with about 3 percent solids among various liquids, and via a combination of electrodes (e.g. at least 609A, 609B in FIG. 8A) “squeeze” the formulation into a paste of at least about 20 percent solids, as noted above. As shown in at least FIG. 8B, the paste of materials 605 is applied as a layer (onto image formation medium 24 having a thickness of about 4 to about 8 microns, in at least some examples. It will be understood that the volume and/or thickness of the electrically charged, semi-liquid layer (forming image-receiving holder 625) that is transferred from the developer unit 602 to the image formation medium 24 may be controlled based on a voltage (e.g. −500V) of the developer roller 608 and/or a charge level of the solid particles within the paste produced by the developer unit 602.

In some examples, as further described later in association with at least FIG. 12A, among directing other and/or additional operations, a control portion 1000 is to instruct, or to cause, the developer unit 602 to apply the electrically charged, semi-liquid image-receiving holder layer 625 onto image formation medium 24, such as within the preliminary portion 710 along the travel path T.

Upon rotation of at least drum 608 of the roller assembly 607, and other manipulations associated with container 605, the drum 608 electrostatically attracts some of the charged developed material to form image-receiving holder layer 625, which is then deposited onto image formation medium 24 as shown in FIGS. 8A-8B.

During such coating, the image-receiving holder layer 625 becomes electrostatically releasably fixed relative to the media. In this arrangement, a first surface 626A (i.e. side) of the image-receiving holder layer 625 faces the image formation medium 24 while an opposite second surface 626B of the image-receiving holder layer 625 faces away from image formation medium 625.

As previously noted, in some examples the image formation medium 24 includes at least some electrically conductive material which facilitates electrostatically attracting the negatively charged paste to complete formation of image-receiving holder layer 625 on a surface 687A of the image formation medium 24, as shown in FIG. 8B. The electrically conductive image formation medium 24 may be electrically connected to an electrical ground 670.

In some examples, the developer unit 602 may include a permanent component of an image formation device (e.g. 300, 400, 500, etc.) with the developer unit 602 being sold, shipped, and/or supplied, etc. as part of the image formation device. It will be understood that such “permanent” components may be removed for repair, upgrade, etc. as appropriate.

As shown in FIG. 8C, in some examples an image formation device (e.g. 300, 400, 500, etc.) may include a receiving structure 692 like receiving structure 550 in FIG. 6A, except to removably receive the developer unit 602 instead of receiving a fluid ejection device 561. Accordingly, in some examples the developer unit 602 is removably insertable into the receiving structure 692, as shown in at least FIG. 8C. In some such examples, the receiving structure 692 is sized, shaped, and positioned relative to image formation medium 24, as well as relative to other components of the image formation device (e.g. 300, 400, 500, etc.), such that upon removable insertion into receiving structure 692 (as represented by arrow V in FIG. 8C), the developer unit 602 is positioned to deliver the image-receiving holder layer 625 onto image formation medium 24.

In some examples, the developer unit 602 may include a consumable which is periodically replaceable due to wear, exhaustion of a supply of materials, developer components, etc. In some such examples, the developer unit 602 may be sold, supplied, shipped, etc. separately from the rest of an image formation device (e.g., 300, 400, 500, etc.) and then installed into the respective image formation device upon preparation for use of the image formation device at a particular location. Accordingly, it will be apparent that in some examples the receiving structure 692 may include part of the preliminary portion 710 of image formation device 700 in FIG. 9 or otherwise precede the first portion 310 in the other example image formation devices.

When the developer unit 602 is present, in some examples its operation may include developing the image-receiving holder layer 625 without any color pigments in the image-receiving holder layer 625, such that the image-receiving holder layer 625 may sometimes be referred to as being colorless. In this arrangement, the image-receiving holder layer 625 corresponds to a liquid-based ink formulation which includes at least some of substantially the same components as used in liquid electrophotographic (LEP) process, except for omitting the color pigments. In addition to being colorless in some examples, the material used to form the image-receiving holder layer also may be transparent and/or translucent upon application to an image formation medium.

In some examples, the image-receiving holder layer 625 may include some color pigments so as to provide a tint. In some such examples, such color pigments may be transparent or translucent as well so as to not interfere with, or otherwise, affect the formation or appearance of an image via the ink particles 34 deposited via a fluid ejection device (e.g. 561).

In at least some examples in which the image-receiving holder layer 625 omits color pigments, the materials of the image-receiving holder layer 625 effectively do not include part of the image resulting from the deposited color ink particles which will be later transferred (with the image-receiving holder layer 625) onto an image formation medium. Accordingly, in some such examples the image-receiving holder layer 625 also may sometimes be referred to as a non-imaging, image-receiving holder layer 625.

In some such examples, the image-receiving holder layer 625 may include a portion of the binder used to form the image on the image formation medium 24, while resin 33 as part of droplets 31 delivered in the first portion 310 of an image formation device (e.g. 300, 400, 500, etc.) provides the remaining desired amount of binder. It will be understood that the term binder may encompass resin, binder materials, and/or polymers, and the like to complete image formation with the ink particles 34. In some examples, a mineral oil portion of the materials 605 (which includes the binder) may be more than 50 percent by weight of all the materials 605.

It will be understood that the resin 33 may be separate from, and independent of, any binders or resins associated with the developer unit 602.

In some examples, the droplets 31 omit charge director additives and therefore may sometimes be referred to as being charge-director-free. In some such examples, the image-receiving holder layer 625 may include some charge-director additives.

In some examples, the developer unit 602 is to apply the image-receiving holder layer 625 in a volume to cover at least substantially the entire surface of the image formation medium 24 in at least the area in which the image is to be formed on image formation medium 24 and immediately surrounding regions. In some examples, in this context, the term “substantially the entire” includes at least 95 percent, while in some examples, the term “substantially the entire” includes at least 99 percent.

In some examples, the image-receiving holder layer 625 is applied to form a uniform layer covering an entire surface of the image formation medium 24 (at least including the area in which an image is to be formed). This arrangement stands in sharp contrast to some liquid electrophotographic printers in which liquid ink (with color pigments) is applied just to areas of a charged photo imaging plate (PIP), which have been discharged in a pattern according to the image to be formed. Accordingly, the application of a uniform layer (covering an entire surface of the image formation medium 24) of the image-receiving holder layer 625 in the example image formation devices bears no particular relationship to the pattern of an image to be formed on the image-receiving holder layer 625. Therefore, in some instances, the image-receiving holder layer 625 may sometimes be referred to as a non-imaging, image-receiving holder layer 625.

FIG. 9A is a diagram including a side view schematically representing an example image formation device 700. It will be further understood that FIG. 9A also may be viewed as schematically representing at least some aspects of an example method of image formation. In some examples, the image formation device 700 includes at least some of substantially the same features and attributes as the previously described example image formation devices (e.g. 300, 400, 500) in FIGS. 3-8C. Accordingly, like the previous examples, the image formation device 700 also provides droplets 31 of resin 33 encapsulated ink particles 34 within a carrier fluid 32 to bind the ink particles 34 in a completed image formation medium assembly.

As shown in FIG. 9A, in some examples the image formation device 700 includes an image formation medium 24, a preliminary portion 710, a first portion 310, a second portion 320, a fourth portion 510, and a fifth portion 715, etc. Operation of the image formation device 700 results in a printed medium assembly 790 as shown in FIG. 9B and which includes a second polymer structure 737 covering and bonding an image formed via ink particles 34 and coalesced resin 33 on image-receiving holder layer 625 on an image formation medium 24. In some examples, the preliminary portion 710 and/or at least first, second, fourth portions (310, 320, 510) include at least some of substantially the same features and attributes as previously described in association with at least FIGS. 3-8C.

As further shown in FIG. 9A, in some examples the preliminary portion 710 of image formation device 700 is to receive a coating of material on the image formation medium 24 to form an image-receiving holder layer 625 in a manner substantially the same as described in association with at least FIGS. 8A-8B.

It will be understood that the image formation medium 24 may be moved along travel path T via support from an array of rollers, tensioners, and related mechanisms to maintain tension and provide direction to image formation medium 24 in its movement along travel path T.

In a manner consistent with the previously-described example image formation devices, electrostatic fixation of resin encapsulated ink particles occurs relative to the image-receiving holder layer 625, thereby ensuring that the resin encapsulated ink particles remain in their targeted locations to form an image. In some examples, the electrostatic fixation occurs relative to the charged binder material in the image-receiving holder layer 625.

As further shown in FIG. 9A, in some examples image formation device 700 may further include fifth portion 715 downstream from at least the liquid removal element 522. Via at least a roller (e.g. drum) 704, heat and pressure is applied while securing a second polymer structure 737 relative to the layer of ink solids (e.g. particles 34), resin 33, image-receiving holder layer 625, and image formation medium 24. In some such examples, this action may include laminating. Moreover, in some such examples, electrical bias also may be used in combination with heat and/or pressure to effect the above-described securing action of the second polymer structure 737.

In some examples, as shown in FIG. 9B, in a completed image formation medium assembly 790 the image made of a pattern(s) of ink particles 34 and resin 33 is at least partially sandwiched between the image formation medium 24 (with image-receiving holder layer 625 thereon) and the second polymer structure 737. In some such examples, some portions of the respective image-receiving holder layer 625 and the second polymer structure 737 may be in direct contact with each other, as shown in FIG. 9B in one example.

In some examples, the image-receiving holder may sometimes be referred to as an image-receiving medium. In some examples, the semi-liquid image-receiving holder may sometimes be referred to as a paste, a semi-liquid base, semi-solid base, or base layer.

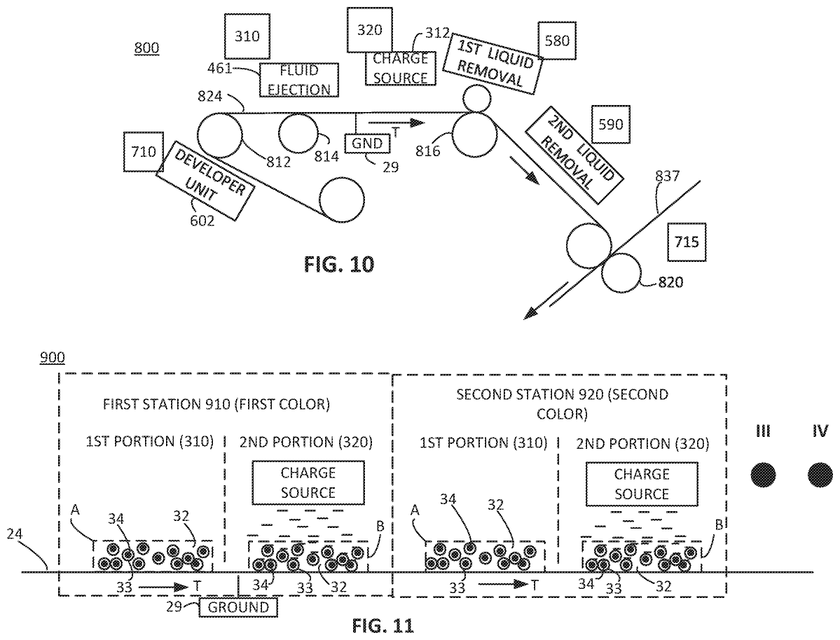

FIG. 10 is a diagram including a side view schematically representing at least a portion of an example image formation device 800. In some examples, image formation device 800 includes at least some of substantially the same features as the image formation devices as previously described in association with FIGS. 3-9B. Accordingly, like the previous examples, the image formation device 800 also provides droplets 31 including ink particles 34 and a resin 33 encapsulating each ink particle 34 within a carrier fluid 32 to bind the ink particles 34 within a completed image formation medium assembly. For illustrative simplicity, the various portions (e.g. 310, 320, etc.) of image formation device 800 are represented via boxes instead of dashed lines as in the earlier example Figures.

In some examples, image formation device 800 may include various rollers 812, 814, 816, etc. and related mechanisms to guide and support travel of image formation medium 824 along travel path T and through the various portions of image formation device 800.

As shown in FIG. 10, in some examples a fifth portion 715 may comprise a cylinder 820 (like roller 704 in FIG. 9A) and/or other rollers to apply a second polymer structure 837 or other cover layer. In some examples, the fifth portion 715 may sometimes be referred to as finishing station, and with the elements in fifth portion 715 in FIG. 10 including at least a partial example implementation of elements in fifth portion 715 in FIG. 9A.

FIG. 11 is a diagram including a side view schematically representing an example image formation device 900. In some examples, the image formation device 900 includes a media supply and a series of stations arranged along the travel path of the media in which each station is to provide one color ink of a plurality of different color inks onto the media. It will be further understood that FIG. 11 also may be viewed as schematically representing at least some aspects of an example method of image formation.

In some examples, the image formation device 900 includes at least some of substantially the same features and attributes as the devices 300, 400, 500, etc., and portions, components, thereof, as previously described in association with FIGS. 3-10. However, in image formation device 900 a series of image formation stations 910, 920, etc. is provided along a travel path of the image formation medium 24. In some examples, each different image formation station 910, 920, etc. provides for at least partial formation of an image on image formation medium 24 by a respectively different color ink. Stated differently, the different stations apply different color inks such that a composite of the differently colored applied inks forms a complete image on image formation medium 24 as desired. In some examples, the different color inks correspond to the different colors of a color separation scheme, such as Cyan (C), Magenta (M), Yellow (Y), and black (K) wherein each different color is applied separately as a layer to the image formation medium 24 as image formation medium 24 moves along travel path T.

As shown in FIG. 11, each station 910, 920, etc. may include at least a first portion 310 and a second portion 320 having substantially the same features as previously described. In some examples, each station may include additional portions, such as but not limited to, portion 510 (FIG. 5). In some examples, the first station 910 is preceded by a preliminary portion 710 (FIG. 9A). Like the previously-described example image formation devices (and/or methods) in FIGS. 3-10, each station (e.g. 910, 920, etc.) or just some stations (e.g. 910, 920, etc.) of image formation device 900 include a first portion 310 which provides droplets 31 including resin 33 encapsulated ink particles 34 within a carrier fluid 32 to bind the ink particles 34 within a completed image formation medium assembly.

As further shown in FIG. 11, the image formation device 900 may include additional stations, and as such, the black circles III, IV represent further stations like stations 910, 920 for applying additional different color inks onto image formation medium 24. In some examples, the additional stations may include a fewer number or a greater number of additional stations (e.g. III, IV) than shown in FIG. 11.

It will be understood that following a series of such stations (e.g. 910, 920, etc.) the image formation device 900 may include a third portion 410, fourth portion 510, and/or fifth portion 715, etc. including at least some of substantially the same features as described in association with at least FIGS. 3-10 to produce a completed image formation medium assembly, such as shown in FIGS. 2 and 9B.

FIG. 12A is a block diagram schematically representing an example control portion 1000. In some examples, control portion 1000 provides one example implementation of a control portion forming a part of, implementing, and/or generally managing the example image formation devices (e.g. 300, 400, 500, 700, 800, 900) including as the particular portions, elements, devices, user interface, instructions, engines, and/or methods, as described throughout examples of the present disclosure in association with FIGS. 3-11 and 12B-13B.

In some examples, control portion 1000 includes a controller 1002 and a memory 1010. In general terms, controller 1002 of control portion 1000 includes at least one processor 1004 and associated memories. The controller 1002 is electrically couplable to, and in communication with, memory 1010 to generate control signals to direct operation of at least some of the image formation devices, various portions and elements of the image formation devices, fluid ejection devices, developer units, charge generation elements, liquid removal portions, finishing elements, user interfaces, instructions, engines, functions, and/or methods, as described throughout examples of the present disclosure. In some examples, these generated control signals include, but are not limited to, employing instructions 1011 stored in memory 1010 to at least direct and manage depositing droplets of resin encapsulated ink particles and carrier fluid to form an image on a media, directing charges onto resin encapsulated ink particles, removing liquids, applying finish treatments, etc. as described throughout the examples of the present disclosure in association with FIGS. 3-11 and 12B-13B. In some instances, the controller 1002 or control portion 1000 may sometimes be referred to as being programmed to perform the above-identified actions, functions, etc. In some examples, at least some of the stored instructions 1011 are implemented as an, or may be referred to as, a print engine or image formation engine.

In response to or based upon commands received via a user interface (e.g. user interface 1020 in FIG. 12B) and/or via machine readable instructions, controller 1002 generates control signals as described above in accordance with at least some of the examples of the present disclosure. In some examples, controller 1002 is embodied in a general purpose computing device while in some examples, controller 1002 is incorporated into or associated with at least some of the image formation devices, portions or elements along the travel path, fluid ejection devices, developer unit, charge generation elements, liquid removal portions, finishing elements, user interfaces, instructions, engines, functions, and/or methods, etc. as described throughout examples of the present disclosure.

For purposes of this application, in reference to the controller 1002, the term “processor” shall mean a presently developed or future developed processor (or processing resources) that executes machine readable instructions contained in a memory or that includes circuitry to perform computations. In some examples, execution of the machine readable instructions, such as those provided via memory 1010 of control portion 1000 cause the processor to perform the above-identified actions, such as operating controller 1002 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1010. The machine readable instructions may include a sequence of instructions, a processor-executable machine learning model, or the like. In some examples, memory 1010 includes a computer readable tangible medium providing non-volatile storage of the machine readable instructions executable by a process of controller 1002. In some examples, the computer readable tangible medium may sometimes be referred to as, and/or includes a computer program product. In other examples, hard wired circuitry may be used in place of or in combination with machine readable instructions to implement the functions described. For example, controller 1002 may be embodied as part of at least one application-specific integrated circuit (ASIC), at least one field-programmable gate array (FPGA), and/or the like. In at least some examples, the controller 1002 is not limited to any specific combination of hardware circuitry and machine readable instructions, nor limited to any particular source for the machine readable instructions executed by the controller 1002.

In some examples, control portion 1000 may be entirely implemented within or by a stand-alone device. In some examples, the control portion 1000 may be partially implemented in one of the image formation devices and partially implemented in a computing resource separate from, and independent of, the image formation devices but in communication with the image formation devices. For instance, in some examples control portion 1000 may be implemented via a server accessible via the cloud and/or other network pathways. In some examples, the control portion 1000 may be distributed or apportioned among multiple devices or resources such as among a server, an image formation device, and/or a user interface.

In some examples, control portion 1000 includes, and/or is in communication with, a user interface 1020 as shown in FIG. 12B. In some examples, user interface 1020 includes a user interface or other display that provides for the simultaneous display, activation, and/or operation of at least some of the image formation devices, portions, elements, user interfaces, instructions, engines, functions, and/or methods, etc. as described in association with FIGS. 3-11 and 12B-13. In some examples, at least some portions or aspects of the user interface 1020 are provided via a graphical user interface (GUI), and may include a display 1024 and input 1022.

FIGS. 13A-13B are flow diagrams schematically representing an example method. In some examples, method 1100 may be performed via at least some of the same or substantially the same devices, portions, stations, elements, control portion, user interface, etc. as previously described in association with FIGS. 3-12B. In some examples, method 1100 may be performed via at least some devices, portions, stations, elements, control portion, user interface, etc. other than those previously described in association with FIGS. 3-12B.

In some examples, as shown at 1102 in FIG. 13A, method 1100 includes selectively depositing, via a fluid ejection device, droplets of resin encapsulated pigment particles within a dielectric, non-aqueous carrier fluid onto an electrically grounded non-absorbing, non-transfer media moving along a travel path to form at least a portion of an image. As shown in FIG. 13A at 1104, in some examples method 1100 includes directing charges onto the resin encapsulated pigment particles within the deposited carrier fluid on the media to induce movement of the charged resin encapsulated pigment particles, via attraction relative to the grounded media, through the deposited carrier fluid to electrostatically fix the charged resin encapsulated pigment particles in contact relative to the media.

As shown in FIG. 13B at 1106, in some examples method 1100 further includes removing the carrier fluid. As shown in FIG. 13B at 1108, in some examples, method 1100 further includes polymerizing the resin to bind the pigment particles to the media. As previously noted, in some examples the method may include encapsulating the pigment particles with a liquid resin in a dispersed phase. In other examples, the method may include encapsulating the pigment particles with a solid resin.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An ink comprising:
a dielectric, non-aqueous carrier fluid;
pigment particles within the carrier fluid; and
liquid resin in a dispersed phase encapsulating each of the pigment particles within the carrier fluid,
wherein the liquid resin is to be polymerized after the ink is applied to a substrate.

2. The ink of claim 1, wherein the resin is insoluble in the carrier fluid.

3. The ink of claim 1, wherein the resin comprises a thermosetting polymer.

4. The ink of claim 1, wherein the resin comprises at least one of polyethylene glycol diacrylate and hydroxyethyl methacrylate.

5. A device comprising:
a supply to supply a non-transfer media along a travel path and to which a ground element is to be electrically connected;
a first portion along the travel path to apply droplets of resin encapsulated pigment particles within a dielectric, non-aqueous carrier fluid onto the non-transfer media to form at least a portion of an image on the media; and
a second portion downstream from the first portion and including a charge generation portion to emit airborne charges to charge the resin encapsulated pigment particles to move, via attraction relative to the grounded media, through the carrier fluid toward the media to become electrostatically fixed relative to the media.

6. The device of claim 5, wherein the resin encapsulated pigment particles are encapsulated with a liquid resin in a dispersed phase.

7. The device of claim 5, wherein the resin encapsulated pigment particles are encapsulated with a solid resin.

8. The device of claim 5, wherein the resin comprises a thermosetting polymer or a thermoplastic polymer.

9. The device of claim 5, further comprising:
a third portion downstream from the second portion to polymerize the resin via UV radiation or heat.

10. The device of claim 5, wherein the first portion is to receive a drop-on-demand fluid ejection device to eject the droplets of resin encapsulated pigment particles within the dielectric, non-aqueous carrier fluid.

11. The device of claim 5, further comprising at least one of:
a first liquid removal portion downstream along the travel path from the second portion to mechanically remove at least a portion of the carrier fluid from the media; and
a second liquid removal portion downstream from the first liquid removal portion and including:
a heated air element to direct heated air onto at least one of the carrier fluid and the media; or
a radiation device to direct at least one of IR radiation and UV radiation onto at least one of the carrier fluid and the media.

12. A method comprising:
selectively depositing, via a fluid ejection device, droplets of resin encapsulated pigment particles within a dielectric, non-aqueous carrier fluid onto an electrically grounded non-absorbing, non-transfer media moving along a travel path to form at least a portion of an image; and
directing charges onto the resin encapsulated pigment particles within the deposited carrier fluid on the media to induce movement of the charged resin encapsulated pigment particles, via attraction relative to the grounded media, through the deposited carrier fluid to electrostatically fix the charged resin encapsulated pigment particles in contact relative to the media.

13. The method of claim 12, further comprising:
removing the carrier fluid; and
polymerizing the resin to bind the pigment particles to the media.

14. The method of claim 12, further comprising:
encapsulating the pigment particles with a liquid resin in a dispersed phase.

15. The method of claim 12, further comprising:
encapsulating the pigment particles with a solid resin.
